(19) United States
(12) Patent Application Publication
(10) Pub. No.: US 2010/0138506 A1
(43) Pub. Date: Jun. 3, 2010

(54) METHOD AND SYSTEM FOR ELECTRONIC GREETINGS

(76) Inventor: Benedict VAN, Palo Alto, CA (US)

Correspondence Address: PILLSBURY WINTHROP SHAW PITTMAN LLP, P.O. BOX 10500, MCLEAN, VA, 22102, US

(21) Appl. No.: 12/630,209

(22) Filed: Dec. 3, 2009

Related U.S. Application Data
(60) Provisional application No. 61/119,643, filed on Dec. 3, 2008.

(51) Int. Cl. G06F 15/16; G06F 3/048

(52) U.S. Cl. 709/206; 715/764

(57) ABSTRACT

The present invention relates to electronic communications, and more particularly to electronic greetings, notes and interpersonal exchanges facilitated by electronic communications such as gifts, music and video. According to some aspects, the present invention provides a platform for users to browse, select, save and send out electronic greetings According to other aspects, the present invention provides a platform for businesses to sponsor and create electronic greetings, and to use such greetings to promote their businesses and products. According to other aspects, the present invention provides a platform for targeting gift ideas using electronic greetings.

### CROSS-REFERENCE TO RELATED APPLICATIONS

The present application claims priority to U.S. Prov. Appln. No. 61/119,643, filed Dec. 3, 2008, the contents of which are incorporated herein by reference in their entirety.

### FIELD OF THE INVENTION

The present invention relates to electronic communications, and more particularly to electronic greetings, notes and interpersonal exchanges facilitated by electronic communications such as gifts, music and video.

### BACKGROUND OF THE INVENTION

The state of the art of World Wide Web technologies (e.g. Web 3.0) has been dramatically advanced by the inventions described in U.S. Prov. Applns. No. 61/031,664 and 61/036,419, the contents of both being incorporated herein by reference in their entirety. Nevertheless, many opportunities for further development remain.

For example, greeting cards and other forms of expression are ubiquitous in daily life. Individuals can typically send and receive dozens of greeting cards each year, and businesses can send hundreds or thousands. Typical printed cards have been used in the past, at a routinely high expense. For example, a business that sends out 350 holiday cards to customers can spend over $750 for a custom card, postage and labor.

Recently, electronic greeting cards by Hallmark and others have been developed and have become popular. In 2007, over 300 million electronic greetings were sent. However, these usually require users to pay for cards, which can be expensive, and require users to go to a dedicated website. Accordingly, it would be desirable if individuals and businesses could be provided an inexpensive and convenient way to send electronic greetings. Moreover, it would be desirable if such functionality could be integrated with, or extended to, third-party websites or web services (e.g. social networking) such as through an API.

Meanwhile, online advertising has grown dramatically in the past, but is currently facing some slowing of growth. Part of the reason is that the technology has matured, and there is very little to differentiate search services such as those provided by Google, Yahoo!, Microsoft and others. For example, for all its successes, Google's search capabilities, search results and targeted on-line ads are not very different in promoting businesses than the capabilities, results and ads provided by Yahoo!. Accordingly, it would be desirable to have a platform that could be integrated with search services and could provide promotional functionalities other than through search results and targeted ads.

Still further, shopping for, ordering and sending gifts on-line has become increasingly popular. However, when multiple types of gifts for an occasion are possible, users often have to search multiple sites, even if they are aware of the different types of gifts. Some sites such as Yahoo! and Amazon.com allow searching for types of gifts for a specific occasion, but these results can typically be too voluminous and time-consuming to sort through, and may often include irrelevant gifts. Moreover, such searches must typically be done independently of sending a greeting. Accordingly, it would be desirable to make the on-line gift-giving experience easier and less time consuming.

### SUMMARY OF THE INVENTION

The present invention relates to electronic communications, and more particularly to electronic greetings, notes and interpersonal exchanges facilitated by electronic communications such as gifts, music and video. According to some aspects, the present invention provides a platform for users to browse, select, save and send out electronic greetings According to other aspects, the present invention provides a platform for businesses to sponsor and create electronic greetings, and to use such greetings to promote their businesses and products. According to other aspects, the present invention provides a platform for targeting gift ideas using electronic greetings.

The present inventions provide many advantages. For example, the inventions allow a site to provide free customizable online greeting cards (i.e. eWishing Notes and Cards) for holidays and everyday occasions. Also, the inventions allow corporate e-cards for promoting companies' products and brand names to be made available on companies' websites via an API feed. Still further, the inventions allow commercial and product placement e-cards, a new, overlooked space for the advertising industry. Moreover, whereas corporate holiday e-cards cost anywhere from a few hundred to several thousand dollars and up depending on the complexity and amount of customization desired, the inventions allow these costs to be greatly reduced. Additionally, the inventions allow relevant gift suggestions (advertisements) to be uniquely positioned alongside greeting e-cards being emailed out. The process is intuitive because the inventions can leverage knowledge about why senders are online (potential gift-seeking customers), and which holiday/occasion they are sending an e-card for (i.e. mom's birthday). Moreover, the process is non-invasive on the users' experience; customers can simply send e-cards without clicking on the ads to learn more if they aren't interested. For example, just as a waiter would suggest a wine pairing for your steak in a fine restaurant, sponsors can utilize their knowledge and power of suggestion to recommend relevant gifts for any and all occasions to e-card senders. Still further, the process provides a value-added experience and Gift-giving made easy. For example, there is no need to visit multiple sites. It also makes the gift-giving experience easier and more enjoyable for consumers as they save time and have access to great gift suggestions.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating an example system for implementing aspects of the invention;

FIG. 2 illustrates an example electronic greeting according to embodiments of the invention;

FIG. 3 illustrates an example of how an electronic greeting can be relayed via email by a system according to the invention;

FIG. 4 illustrates an example of how a recipient of an electronic greeting can be redirected to a site for viewing a sent greeting according to the invention;

FIG. 5 illustrate example stamp shapes according to aspects of the invention;

FIGS. 6A to 6C illustrate an example method of opening and displaying an electronic greeting for a recipient according to embodiments of the invention; and

FIGS. 7A to 7F illustrate example aspects of how personal messages can be accessed and displayed for a recipient according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

In general, the present invention provides a new platform (e.g. a virtual city site such as eCity as described in U.S. Prov. Applns. No. 61/031,664 and 61/036,419, the contents of both being incorporated herein by reference in their entirety) for users to browse, select, save and send out their favorite electronic greetings (i.e. eGreetings or eWishing Notes/Expressions). Eventually, they will be able to build their own, add music, etc.

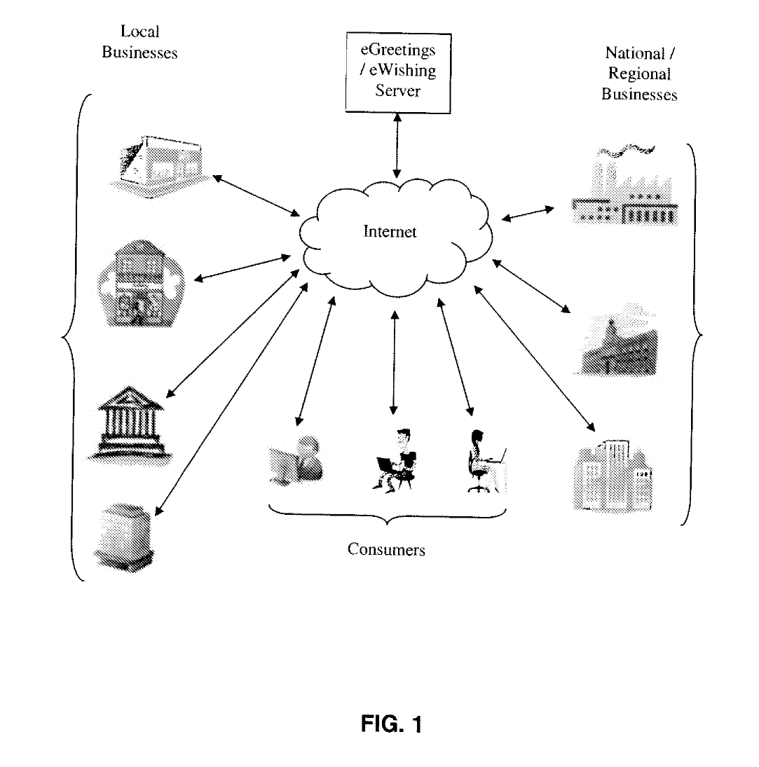

FIG. 1 illustrates certain aspects of the invention as implemented using a platform described in the co-pending applications. Those skilled in the art will appreciate various additional or alternative embodiments after being taught by this example. For instance, whereas this example describes a dedicated server, the invention can be made available as an API or remote service that is accessible via other web servers such as those hosted by individual third party web sites.

As shown in FIG. 1, an implementation includes a eGreetings/eWishing server that is accessible via the public Internet via one or more domain names (e.g. www.eCity.com). It should be apparent that there can be more than one server, and that the Internet can include many different types of wired and wireless networks.

As further shown in FIG. 1, the eGreetings server is accessed by local businesses, consumers, national/regional businesses, and international businesses and organizations. It should be apparent that these groups are not necessarily mutually exclusive. For example, a consumer can also have or be associated with a business.

Local businesses can include stores, doctors, dentists, agencies, banks, professional services, car dealerships, movie theaters, etc. Local businesses can also include non-commercial groups such as churches, government agencies, etc. Local businesses can also include local branches of nationwide or regional businesses or organizations.

National/regional and international businesses and organizations can include manufacturers of consumer and industrial goods, financial organizations, governments, etc.

eGreetings/eWishing server can be implemented by one or more servers such as those available from Sun, HP, BEA, etc. It can further includes associated software comprising, for example, operating system(s), web server(s), database server(s), and other server software. The server can maintain other conventional user account information such as usernames, passwords, contact information, etc., either in databases or other locally or remotely accessible storages.

Users such as consumers and business can access the eGreetings/eWishing server using any type of computing device a person can now or in the future use to access the Internet or other public network, and which can host at least Internet access hardware (not shown) and software such as a browser. In an example where users have a personal computer such as a Mac, PC, notebook or desktop computer, it typically includes an operating system such as Windows or Mac OS, a browser application such as Windows Explorer or Mozilla Firefox, and network access hardware such as a wired or wireless modem. Computing devices used by consumers and businesses further preferably include graphical displays (e.g. one or more LCD screens) and I/O devices (e.g. keyboard, mouse, keypad, scroll wheels, microphone, speakers, video or still camera, etc.) for providing a user interface within the operating system and communicating with users. Computing devices used by users are not limited to personal computers, but can include cellular phones, personal digital assistants (PDAs), game systems (e.g. Playstation, Wii, Xbox, etc.) or other devices, and those skilled in the art will understand how implementation details can be changed based on the particular type of host device.

Like other eGreeting card sites, embodiments of the invention offer a wide array of categories targeting different events, interests and topics. However, the present invention provides some categories that other sites don't have (e.g. trivia, horoscopes, favorite cities, etc).

According to some aspects, the present invention provides personalized, local business eWishing Notes. These allow users to directly advertise in a relevant, fun and creative eGreeting card format that solely features your top products/services in a graphically and verbally clever way. Eventually the goal is to get every business in every city involved. These help local businesses with their marketing efforts by designing their very own line of eWishing Notes.

For example, consider a local flower shop or bakery. The flower shop or bakery can provide eCity's graphic designers images of their different floral arrangement combinations and pastries/cakes. Then we'll design eWishing Notes using the supplied photos for that flower shop and bakery. When customers purchase flowers for someone else or a cake, they have a choice to make.

1) They can send an eWishing Note to the intended recipient to surprise them right away and give them a heads-up that a bouquet or cake is on its way to them.

2) They can decide not to send an eWishing Note ahead of time if they want the arrival of the gift (i.e. cake or flowers) to be the surprise itself.

The flower shop and bakery can also send eWishing notes out to customers to alert them to special promotions, upcoming sales, etc.

According to other aspects, the invention can allow corporations, organizations, etc. to sponsor eWishing Notes (making them free for consumers to send) using the eCity eGifting Advertising Solution. This is a new way to advertise and is highly suggestion-driven.

HOW IT WILL WORK: Match relevant age and gender profiled ads with categories targeted toward specific markets. Ads will appear on the same viewing plane as the area in which eWishing Note senders fill out the message and delivery details. The eWishing Note senders are potential gift-seeking customers. The ads won't be intrusive. Through the power of suggestion, different gift suggestions (advertisements) will be engaging and relevant because we will have an idea whom the intended recipient is Gift giving made easy. Consumers can send an eWishing Note and get a gift in one place, which saves them time. A one-stop gift-giving solution.

For example, if a Mother's Day card is being sent out, relevant gift ideas like the following could appear in the gift suggestion panel: flowers, chocolate, books, etc. Interested customers can click on an ad that appeals to them and make a gift purchase without all of the hassle of searching for a gift on their own. The gift is an expression of your feelings for someone as is an eWishing Note/Expression. The two work together hand-in-hand. They make a powerful combination that generates more awareness of, interest in and desire for a company's brand.

According to further aspects of the invention, the system provides eWelcome Cards. One example embodiment is to fully integrate the card concept into our business directory in a highly innovative way.

What is an eWelcome card? It is a new and improved ecard that is imbedded with a video showcasing the business. In embodiments it will be tightly edited within a 30-second window. It summarizes the top selling points of the business in a compelling fashion. It provides a promotional benefit (i.e. discount) to new customers. It is highly mobile and quick to download so that it can be shared with tons of new customers. It is personalized and signed by the business owner and either sent from the business itself or a current customer.

Several versions are possible. A first example is for a business to current customer. Purpose: seasonal thanks, promotional, referral focused (will offer new customers a discount to shop at the business). Another example is for Customer to friends. This will be a version made that will be posted on the company's business directory page, which will allow the customer to spread the word and welcome their friends in a personal way. The card will showcase the strengths of the business and the customer can share his/her thoughts about the business. Also the card will provide a shopping discount for first time users. Another example version is for gifting occasions. For example, eGifting Cards are simple promotional codes imbedded within the eWelcome Cards. For now the customer can share a general welcome video that will warm them up to their use of the eGifting Card and give them some added inspiration and direction for finding gifts there.

In embodiments, customers can grab real time photos or video streams that capture their favorite parts of the store or are focused more on their personal experience within the store (i.e. to share your favorite things in a store with friends, to give them the heads-up before they go there, to help out your Secret Santa, I saw this and thought of you, spotlight your fave things, etc.). The customer will become the greatest ally of the business owner because no one knows their friends and family better than the customer does. They can help frame the marketing message in a way that is customizable to the recipient. In other words, let's say the average guy is not aware that there are cool shoes in a retailer. The customer, for example a woman, has a lot of male friends and she can put the spotlight on this section of the store (i.e. grabbing real time web 3.0 feeds and imbed them within a nice personal message that she can then email out to her respective friends). The card can incorporate a soundtrack or the sender's own voice. Tagging mechanisms are also possible (e.g. check this out, smiley faces, etc.).

Embodiments of the invention use the eCity planet technology (see the co-pending applications) and imbed it within the functionality of the eWelcome Cards where the user can click on different images or objects within the video or picture frame and capture a detailed 3D view. Embodiments allow registered users of eCity to experience customization of ecards in a revolutionary way. From business affiliates that offer in store real-time image content, it will be made available to our users who want to customize and take snapshots of the business. This way they can share a small slice of eCity planet with their friends from their perspective. This in turn will help promote eCity and further promote the businesses in a more dynamic way.

Following are some features that are preferably provided in embodiments of the invention:

The ability to update gift suggestions as often as desired, for example to stay seasonally relevant.

Offer suggestions for eWishing Cards in multiple languages and allow users to translate them into any language

Ability to advertise egifting advertising solution in print or any form of media.

Ability to assign tracking numbers to ecards for promotional discounts, etc.

Ability to pay businesses using the cards on a click-thru basis and on a fee-basis for helping them design the cards.

As mentioned above, embodiments of the invention provide suggestion driven ads (gift suggestions) that are placed alongside the area where people fill out ecard delivery and message details, i.e. eGifting Expressions. Preferably, the system offers gift suggestions (in a concise visual/text format) within the eWishing Expression area that is part of the sender's write your message and preview box.

As further mentioned above, embodiments of the invention provide personalized, local business (within each city/town), i.e. eWishing Notes. Preferably, the system offers ability to create ecards for businesses in all of the cities all over the world. Additional or alternative embodiments provide eWelcome cards—the use of any business related video or any other form of multimedia in an ecard format (i.e. interviewing the business owner, sound bites, etc.) According to some preferable aspects, the following features are provided or made possible:

The use of ecards with the business as the centerpiece of the ecard and populating the ecard with commercially-based branding content.

The ability to have businesses use ecards for their own commercial use and advertising.

The ability to email ecards directly from a business directory (we don't want Yellow Pages to copy us) and from eCity Planet!

The ability to create ecards that have gift cards embedded within them

The ability to have the patent on customizing web content from eCity into an ecard format for every city and town in the world

According to further embodiments, the invention provides Corporate Holiday eWishing Notes/Cards. Different options: Branding; Commercial (video or animated flash)—with our bigger budgeted accounts; Work with movie producers to create eWishing Notes to promote upcoming movies; Work with late night talk show hosts (i.e. SNL, David Letterman, Jay Lena, Conan O′Brien, Jimmy Kimmel, etc.) to do comedy holiday sketches i.e. Top 10 Reasons to Bank with Citibank in 2009; Work with celebrities, movie stars & musicians (i.e. Oprah . . . gives list of products she recommends or Bono sings on the Citibank eWishing Note and says “Our friends at Citibank and us wish you and your family a blessed holiday season. Join us on tour at our next concert this year.”); Maybe offer a discount—10% on tickets? (for example, American Express—incorporate their celebrity endorsers in an eWishing Note, i.e. Ellen, Beyonce, Tina Fey, Martin Scorcese, etc.); Big events (i.e. Olympics, Super Bowl, sitcoms, etc.)—have the athletes/stars thank the network in the context of the eWishing Notes.

One aspect of embodiments of the invention is Promotion: i.e. “because we value you as a customer, we'd like to offer you 10% off you next purchase/stay.”

Another aspect is a **Donation Option: Companies can mention that they will be making a corporate donation to a charity and ask customers who receive a corporate holiday card to follow a link and vote online for the charity that they want to receive the donation. Involves customers in the act of giving—warm and fuzzy feelings abound. Customers also feel empowered as they are involved and their opinions are valued. Non-corporate on ecity eWishing Notes and Cards (for consumers—the YouTube of e-cards!). This allows individuals to upload their own videos, images, etc. (similar to YouTube) within an ecard (eWishing Note or Card) format. Easier and more enjoyable to pass along and share than a YouTube link buried in an email

According to some embodiments, all eWishing Notes—corporate and consumer—arrive in a stamped envelope. The format preferably has the following features:

Includes the ability to interact with it—it flips over, envelope opens, eWishing Note pops out and then it flips over in the end to reveal your personal message (like you're interacting with a card in real life)—makes it more exciting

Includes e-photo stamps—design your own

Envelopes: senders get to customize them (select what color and/or design they want their envelope to have select what stamp to put on it (customization options here too), Select the font color, size, font, etc.)

In general, the envelope has the following features. Recipients will see the front of the envelope and the address areas will be filled out with “to” and “from” and can include a logo as well. Click and the envelope flips over; click on the seal and it opens; out pops your eWishing Note; you see the note and then it flips to your personal message on the back at the end.

In general the stamp has the following features. People can select from a few different stamp shapes. The system can create different stamps that people can select from: (city stamps, Corporate & university stamps—branded (print them too?), Photo stamps) i.e. engagement photo for save-the-date, newborn babies, weddings, pets, etc.), Select from our design library of stamps (i.e. Ghirardelli candy bar stamp and you can insert your face on it, your face on a Cheerios or Life cereal box—your favorite cereal whatever it is, super-impose your image on different brand package images), Build your own stamp. According to some aspects, stamps include the ability to flip the stamp over and see copyright information—who took the photo, etc. Stamps can also help promote businesses (i.e. photographers, etc.)

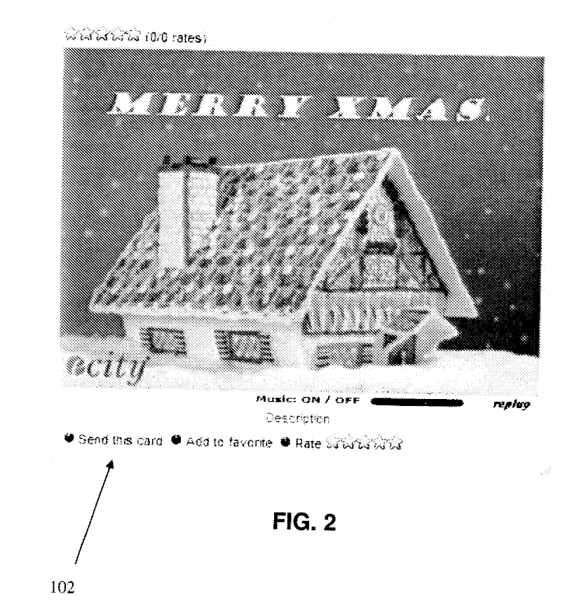

FIGS. 2 to 6 illustrate an example electronic greeting method and system according to certain aspects of the invention.

A sender picks an eWishing Note to customize as shown in FIG. 2. After the customization has been completed, the sender sends it out, for example by clicking on a button such as 102 in FIG. 2.

The system sends an email which arrives in the recipient's inbox. In embodiments, the Subject line reads: “{recipient's name}, [sender's name] has sent you an eCity eWishing Note”. It is possible to add a voice to the email recipients receive that says something like “You've got an eWishing Note” or “You've received an eWishing Note”—similar to the movie—“You've Got Mail”.

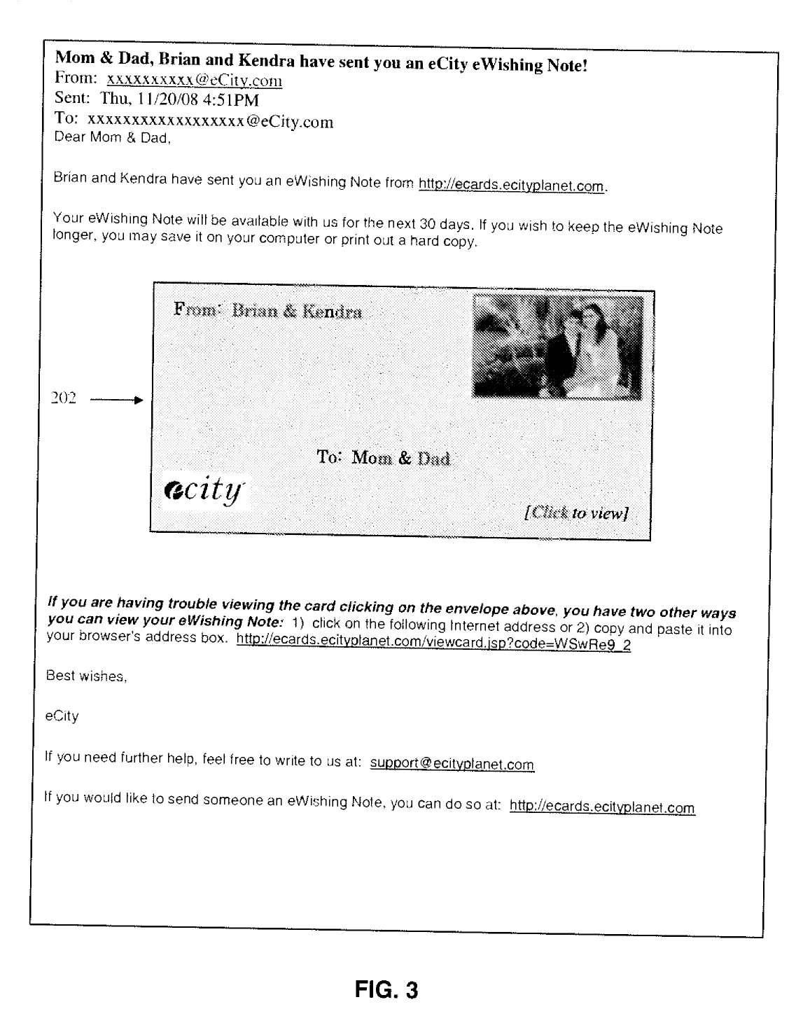

When the recipient opens the email the email contents appear like that shown in FIG. 3, which includes an image of the eWishing Note 202.

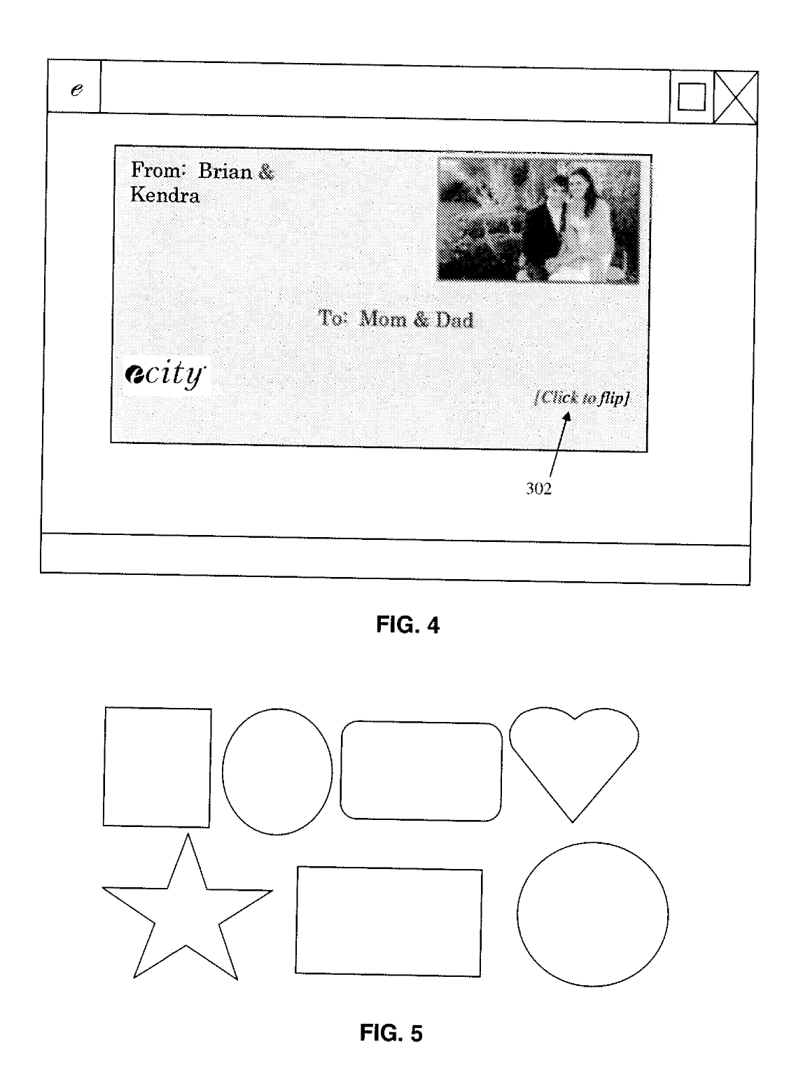

When the recipient clicks on the image 202, their browser will be directed to the system web site (e.g. eCity Greetings site). FIG. 4 shows a view of how an envelope front on the eCity Greetings site will be automatically displayed on the recipient's web browser once they click on the envelope 202 in their Inbox.

In the example shown in FIGS. 3 and 4, the envelope includes a rectangular-shaped stamp with a customized photo inside. Many variations of stamps are possible, as mentioned above. Moreover, FIG. 5 shows the stamp shape options that senders can select from other than rectangular as shown in FIG. 4.

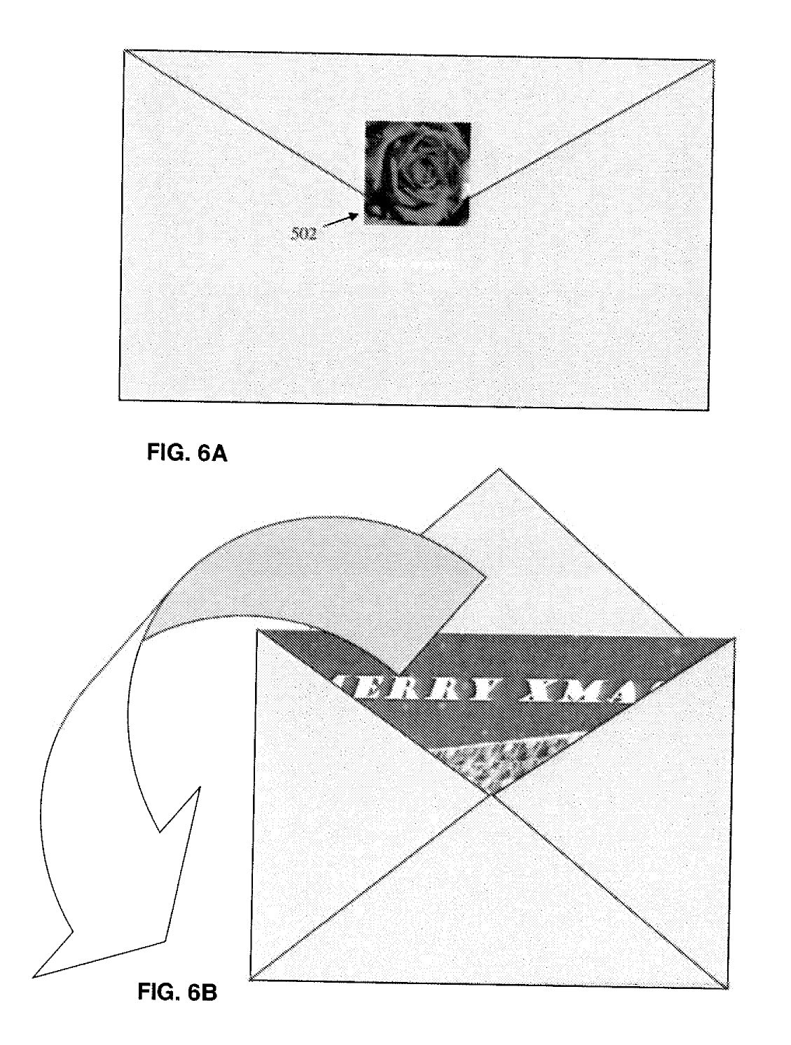

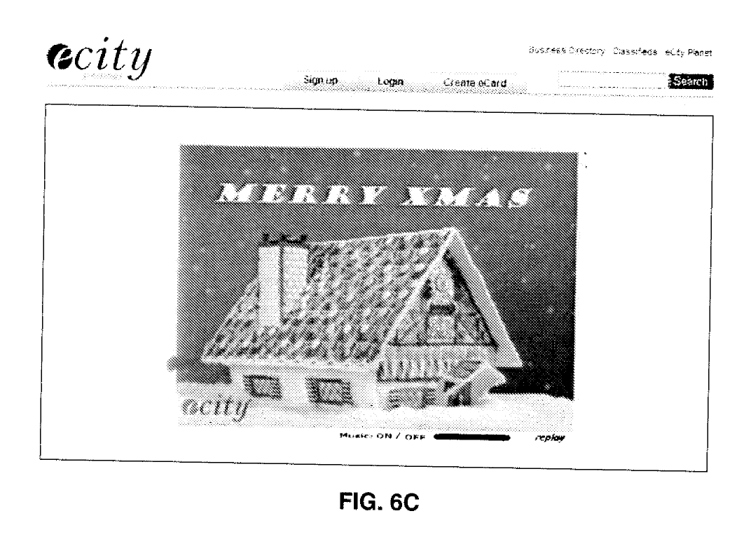

As shown in FIG. 4, the envelope includes a button or similar control 302 that allows the envelope to be flipped over to begin the envelope opening process. An example process for opening an electronic greeting according to embodiments of the invention will now be described in connection with FIGS. 6A to 6C.

FIG. 6A shows a Back of envelope with sticker 502. Preferably, senders can select from various stickers to seal the back of the envelope. Stickers can be interactive flash or static (e.g. Card sticker 502 shown in FIG. 6A (red rose) can bloom open as the seal breaks and the envelope itself opens); or some stickers can be static. The system can allow people to save their favorite stamps and stickers to their “My Favorites” folder to use again in the future.

FIG. 6A shows how it will appear when the receiver is online and has flipped the envelope over. Then they just need to click on the envelope sticker 502 to open it, as shown in FIG. 6A. In embodiments, it is preferable to have a standard, simple envelope design set as a default so people who are in a hurry or don't really want to personalize the envelope, etc. can send an eWishing Note quickly and not get frustrated

As shown in FIG. 6B, when sticker 502 is clicked on, an animation displays in which the envelope seal breaks and envelope opens. The receiver can see a bit of the eWishing Note peeking out of the envelope as you do when you open a envelope in real life and a card is inside. FIG. 6C shows how the Note will finally be displayed after the envelope is opened and disappears.

At this point, a Flash with graphics, audio, theatrics, etc. is automatically played (e.g. a Holiday song with animation.) This is not necessary in all embodiments, however. Moreover, live or recorded video and other multimedia presentations are possible. In some embodiments, after the Flash completes, the Note automatically flips viewed and the sender's personal message can appear in its place.

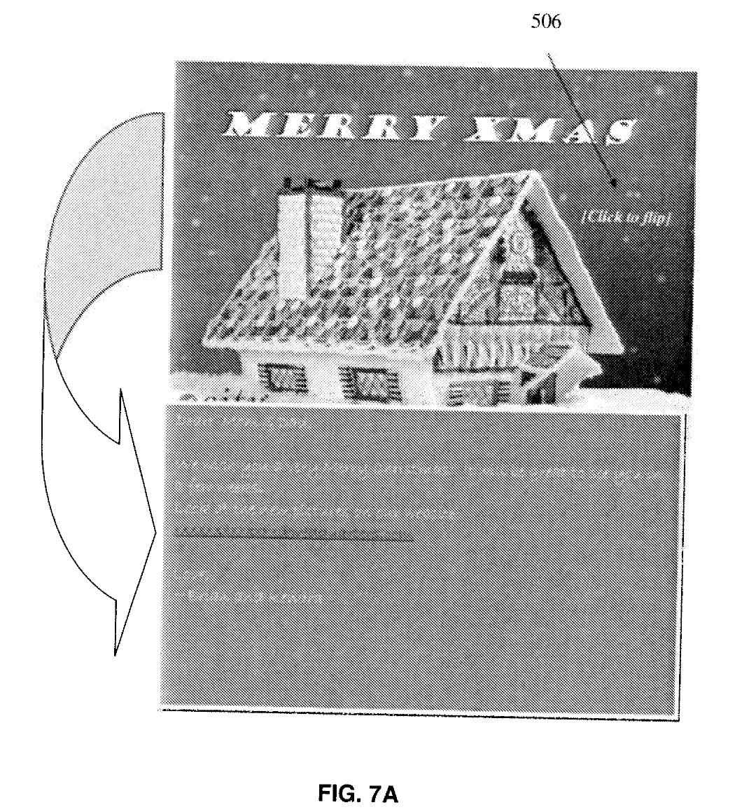

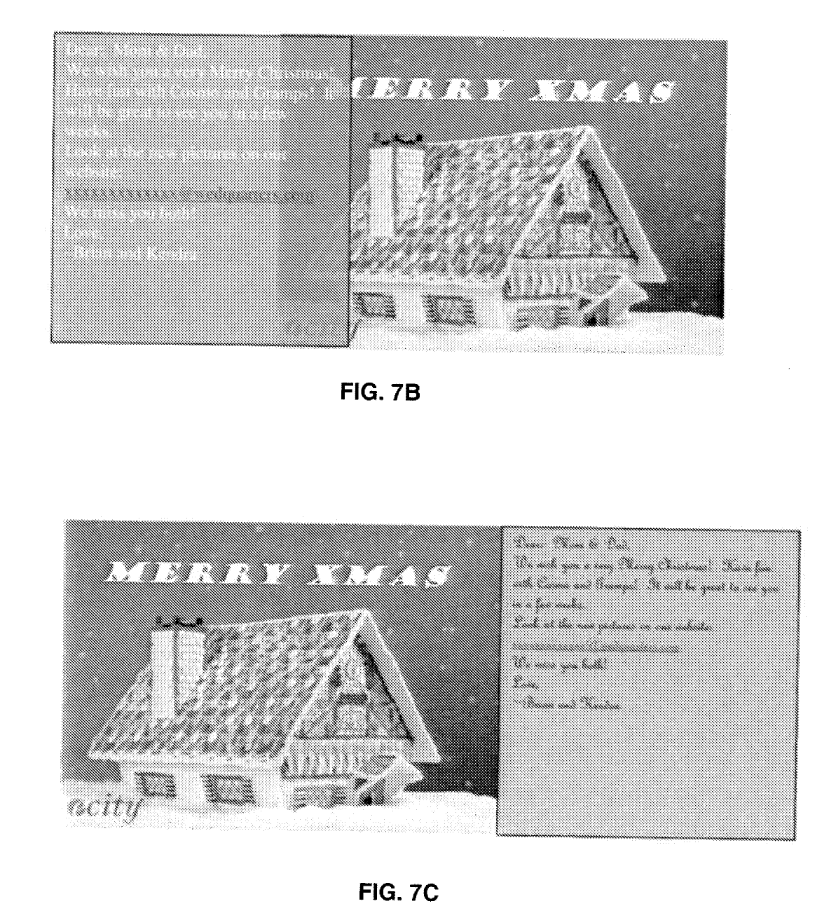

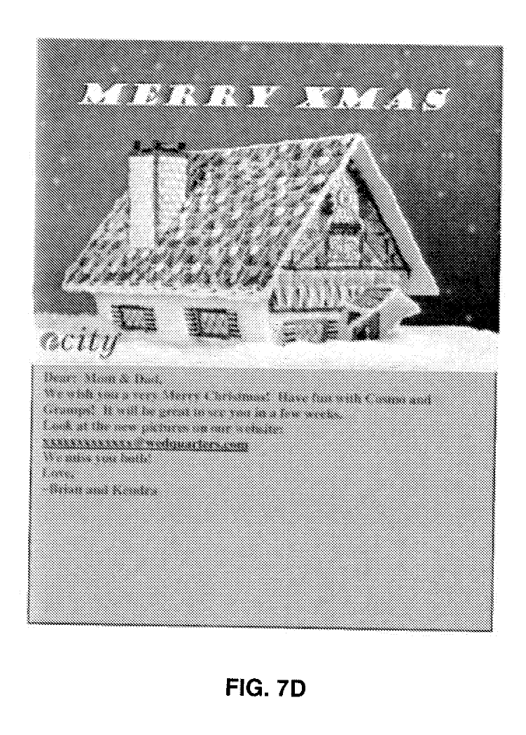

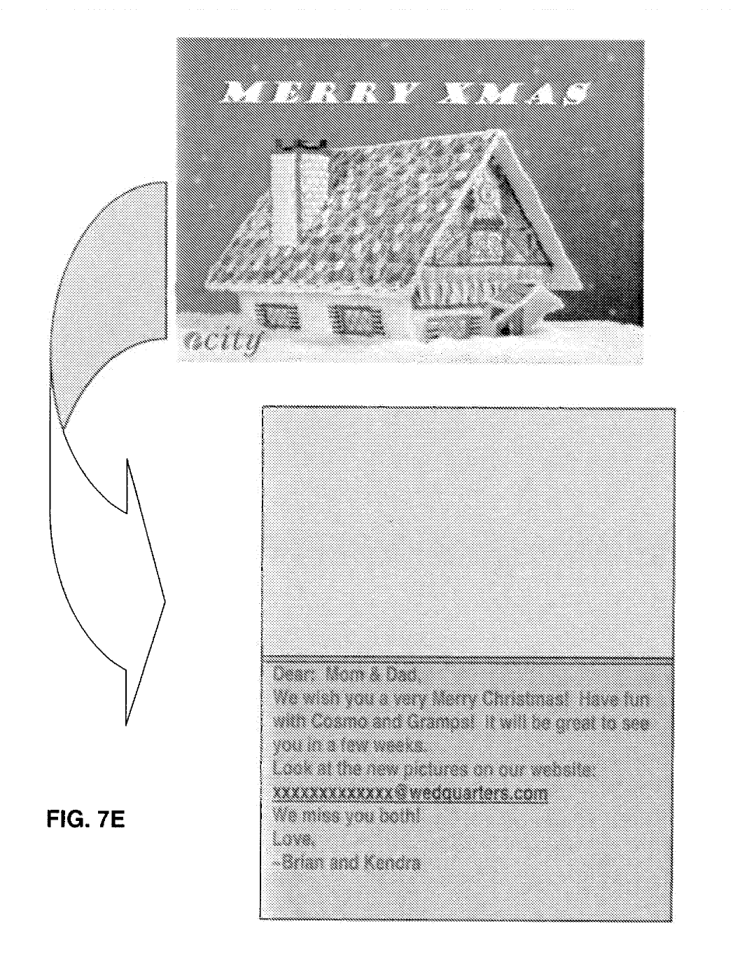

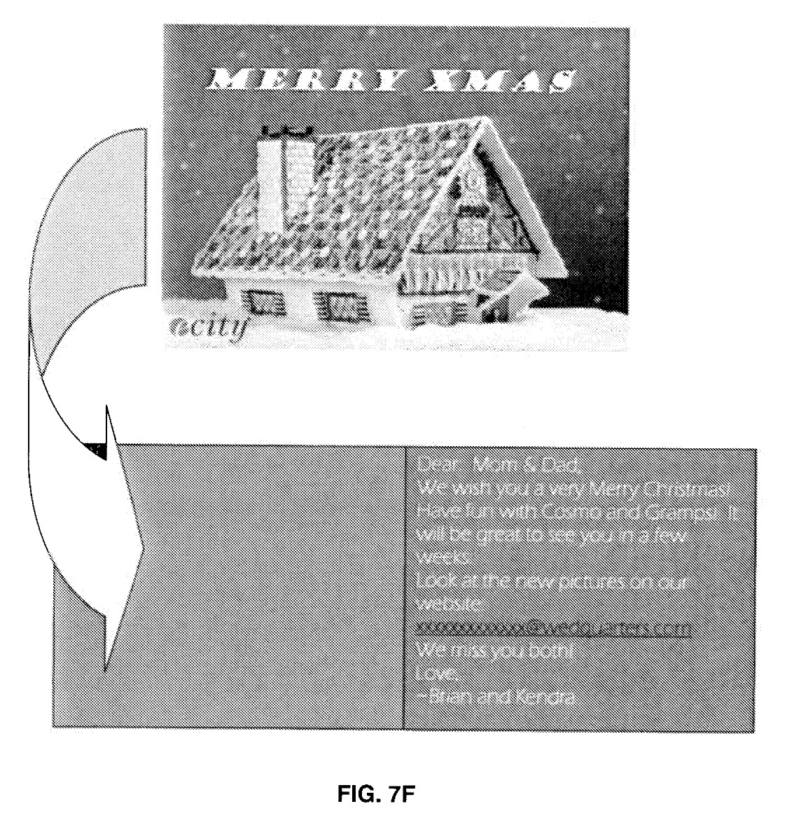

FIGS. 7A to 7F show various possible embodiments of how a personal message can be displayed in addition or alternatively to the embodiments described above.

As shown in FIG. 7A, the personal message will appear on the back side of the note via an animation that causes the card to flip over after the receiver will hits button 506 [click to flip] to see it.

As shown in FIG. 7B, the personal message will appear beside and overlaying the card visual after the Flash, etc. is done entertaining the receiver with its graphics/theatrics, and/or the receiver hits button 506.

As shown in FIG. 7C, the personal message will appear completely beside the card visual after the Flash, etc. is done entertaining the receiver with its graphics/theatrics, and/or the receiver hits button 506.

As shown in FIG. 7D, the personal message will appear beneath the card visual after the Flash, etc. is done entertaining the receiver with its graphics/theatrics and/or the receiver hits button 506.

As shown in FIG. 7E, when the receiver hits button 506 [click to open], the front of the card flips up to reveal the personal message inside the card

As shown in FIG. 7F, when the receiver hits button 506 [click to open], the front of the card flips open to the side (to the left) to reveal the personal message inside the card

The following summarizes various aspects and embodiments of the invention (Note: all options below can be either static or flash)
1. eCity eWishing Notes (visualize a note card type format)
   a. horizontal view—note appears alongside (to left or right of) the visual
   b. vertical view—note appears below the visual
2. eCity eWishing Cards
   a. opens horizontally
   b. opens vertically
3. eCity Cityscape Postcards (city postcards will be included here)
   Vertical
   Horizontal
4. eCity Corporate Holiday Cards
   a. vertical
   b. horizontal
5. eCity Corporate Welcome Cards (these will be an offering, which businesses must pay for, on our eCity Business directory—the public can email them out to their friends and family to let them know/introduce them to a great restaurant, stores, etc. Companies can include video, photos, commercials, promos, product placement, etc. in them to attract new business)
   a. horizontal
   b. vertical

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A server that is accessible via the public Internet, comprising:
a database comprising a plurality of customizable electronic greetings;
an interface for allowing a person that accesses the server to one or more of select and customize one of the customizable electronic greetings; and
a mechanism for allowing the person to electronically send the selected/customized one of the customizable electronic greetings to one or more other persons.

2. A method, comprising:
making a database comprising a plurality of customizable electronic greetings accessible via a server on the public Internet;
allowing a person that accesses the server to one or more of select and customize one of the customizable electronic greetings; and
allowing the person to electronically send the selected/customized one of the customizable electronic greetings to one or more other persons.
